(19) United States
(12) Patent Application Publication
(10) Pub. No.: US 2009/0265977 A1
(43) Pub. Date: Oct. 29, 2009

(54) Portable Insect Misting System

(76) Inventors: Helen Joyce Sullivan, Campbell, TX (US); Lawrence Eugene Sullivan, Commerce, TX (US); Kenneth Eugene Sullivan, Campbell, TX (US)

Correspondence Address: Helen Joyce Sullivan, 4021 Hwy 50, Campell, TX, 75422, US

(21) Appl. No.: 12/108,229

(22) Filed: Apr. 23, 2008

(51) Int. Cl. A01M 7/00

(52) U.S. Cl. 43/132.1; 43/124

(57) ABSTRACT

A portable, light-activated, mist sprayer system comprising direct current power supply, a container of treating fluid at a desired concentration; a motor and pump that are activated at the appropriate time as determined by the switch or timer; at least one sprayer nozzle that will dispense a mist containing the treating fluid whenever the pump is operating; and a timer that turns off the pump after a preset interval to terminate the spraying cycle. A preferred utility for the system of the invention is spraying dilute solutions of insecticide or insect repellent in a mobile fashion while in areas away from a power source or away from larger stored amounts of insecticides.

### FIELD OF THE INVENTION

This invention relates to a portable device useful for spraying a fluid mist through a sprayer head to treat the atmosphere in a desired location proximal to the device, and more particularly, to a self-contained, mobile, pump-driven mist sprayer that initiates a flow of treating fluid of desired intensity and duration. Once initiated, the flow of fluid mist through the sprayer desirably continues for an adjustable time interval. A preferred use of the system is for eradicating or repelling flying or crawling insects in locations remote from AC power outlets during the periods of significant insect activity that typically occur around dusk and dawn. An insect attractant, either alone or in combination with a pesticide, can also be dispensed using the subject device.

### BACKGROUND OF THE INVENTION

The liquid container has the capacity to hold 2.75 gallons of misting solution. The container also has a compartment which houses a 12 v battery, a 12 v pump/motor, and a 12 v digital timer. When set up, a ¼″ nylon high pressure tube runs from the pump to the outdoor area that the customer want to spray for insects. The misting solution is sprayed through nickel-plated nozzles that are spliced into the tubing approximated 10 feet apart and 8′-10′ off the ground.

We have been in the insect misting business for over 20 years. The applications have always been in barns (called fly spray systems), around houses, and other commercial applications. These systems are always permanently attached to a structure. When set up, a traditional system generally has a 55-gallon drum filled with the misting solution. On top of the drum lid is mounted a pump, motor and timer. When filled with the misting solution, the weight of the drum is approximately 480 lbs. In other words; immovable. Our idea was to come up with a way that people could take a system with them while camping, weekend use on the patio, etc. Our Portable Insect Misting System is lightweight, easy to set up and utilizes the technology that we have been using for years.

### PRIOR ART

Problems associated with the presence of mosquitoes and other flying insects are well known, particularly during summer months when people typically engage in many outdoor activities. People have long appreciated the dangers associated with mosquito-borne diseases such as malaria and equine encephalitis. More recently, publicity associated with the West Nile virus in has heightened public awareness of dangers that can be associated with mosquito bites. Additionally, people are generally aware of the pain, discomfort and potentially dangerous allergic reactions that can accompany the bites of various flying and crawling insects encountered outdoors in either urban or rural areas.

Various chemical sprays and devices have previously been used to control flying and crawling insects, spiders, and other such pests. Chemical sprays containing environmentally acceptable concentrations of insecticides or pesticides have historically been applied using hand-held sprayers, fogging machines, and the like. Such sprays are sometimes applied by governmental agencies in parks, residential neighborhoods and other high-risk urban areas, but are most often applied by individuals using hand-held sprayers in and around their own homes and yards. In more rural settings, sprayer systems have previously been used to spray insecticides or pesticides in and around barns, livestock holding areas, and the like. Other devices that have previously been used to control insects and other pests have incorporated a lure or an attractant, such as food baits, light, pheromones, or carbon dioxide, to draw the insects or pests to a trap, electrically energized grid, or poison.

Many of the prior art systems and devices for controlling insects and pests are operated directly by the user. Others are controlled by timers that are preset to initiate their function at a particular time and for a particular interval. In some cases, the electrical energy required to operate the devices, particularly those disposed in remote or rural areas where electricity is not readily available, is obtained from batteries or solar cells. U.S. Pat. No. 6,192,621, for example, discloses a pest control device for outdoor use comprising a solar-powered fan that enhances the circulation of odorous repellent to the external ambient environment. U.S. Pat. No. 5,763,873 discloses an agricultural implement for spraying herbicides on weeds that utilizes a photo-detector circuit to avoid spraying the herbicide on bare soil. The photo-detector circuit is not affected by changes in ambient lighting conditions.

Notwithstanding the systems and devices previously disclosed, a mist sprayer system is needed that is portable and does not require an AC power source, that will activate manually or by using a remote transmitter, and that will be effective for eradicating or repelling flying and crawling insects, spiders and the like from outdoor areas in which the system is deployed. A portable mist sprayer system is also needed that can be easily transported to remote locations such as camping, cook outs or out buildings away from power grids.

### SUMMARY OF THE INVENTION

The present invention is a portable, self-contained, mist sprayer system that preferably comprises a direct current power supply; a container of treating fluid at a desired concentration; a motor and pump that are activated at the appropriate time as determined by the timer; at least one sprayer nozzle that will dispense a mist containing the treating fluid whenever the pump is operating; flexible tubing or other conduits providing fluid communication between the fluid source and the pump inlet, and between the pump outlet and the sprayer nozzle; and a timer that turns off the pump after a preset interval to terminate the spraying cycle. According to a preferred embodiment of the invention, the electronic control unit, a pump control module, and optionally, a remote transmitter for activating the pump control module.

The system of the invention can be easily, effectively and reliably used to dispense a variety of treating fluids, most preferably liquids containing dissolved, entrained or suspended gaseous or powdered solid components. The treating fluids are preferably dispensed as a mist, and are preferably selected from known, commercially available insecticides, pesticides, insect or pest repellents, fungicides, biocides, and the like. It will also be appreciated upon reading the disclosure that the subject system can likewise be used for dispensing other treating fluids “on demand” including, for example, liquid fertilizers, air fresheners, cooling water, and the like.

The system of the invention replaces standard timers or programmed controllers previously used in automated fixed dispensing systems, and, because the dispensing cycles are triggered manually while moving or when stable. By automatically initiating chemical treating for defined intervals in specific areas, the device becomes more user friendly and adaptable. Prior systems are usually permanently attached to a structure. When set up, a traditional system generally has a 55-gallon drum filled with the misting solution. On top of the drum lid is mounted a pump, motor and timer. When filled with the misting solution, the weight of the drum is approximately 480 lbs and far from mobile. The system of the invention allows people to take a system with them while camping, weekend use on the patio, etc. Our Portable Insect Misting System is lightweight, easy to set up and take down, and utilizes the technology that we have been using for years.

We have invented a Portable Insect Misting System that people can carry with them and use around outdoor entertainment areas to get rid or repel nuisance insects such as mosquitoes, ants, spiders, wasps, no see ums, etc.

### BRIEF DESCRIPTION OF THE DRAWING

FIG. 1 is a persepective view of the top, front, right side of the portable insect misting system comprising;

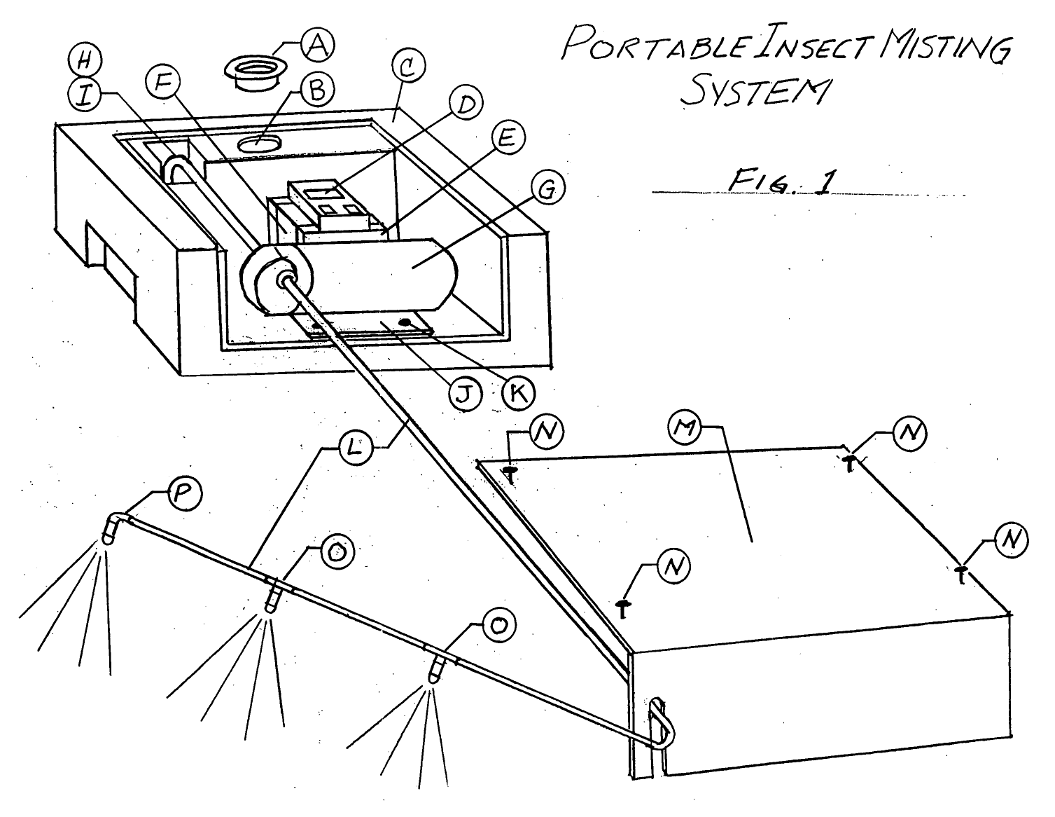

A. Fill Hole Plug

B. Fill Hole

C. 2.75 Gallon HDPE Container

D. 12 v Digital Timer

E. 12 v Battery

F. Battery & Timer Mounting Bracket

G. 12 v Pump/Motor

H. Suction Tube

I. Return Tube

J. Pump/Motor Mounting Bracket

K. Mounting Screws

L. Nylon High-pressure Misting Tube

M. HDPE Lid

N. Lid Thumbscrews

O. Regular Nickel-plated Misting Nozzle

P. Dead-end Nickel-plated Misting Nozzle

### DETAILED DESCRIPTION OF THE INVENTION

Q. Fill Hole Plug—this is a plastic plug that is used to cover the 2″ diameter Fill Hole (Part B) in the Container (Part C). It is approximately ¾″ deep. It is not designed to be watertight.
R. Fill Hole—this is a 2″ diameter hole in the Container (Part C) that is used to fill the Container (Part C) with the insecticide and water.
S. 2.75 Gallon HDPE Container—this is the reservoir for the misting solution. It has been specifically designed to hold 2.75 gallons of liquid. The container is rotationally molded of high-density polyethylene. The container is also formed such that it has a recessed compartment that houses the 12 v Pump/Motor (Part G), the 12 v Battery (Part E), and the 12 v Digital Timer (Part D). The container is approximately 16″×16″×6″ in size. It is also designed with 2 hand grips molded into opposite sides of the container for ease of lifting.
T. 12 v Digital Timer—the timer controls when the system will turn “On” and “Off” during a 24-hour period. There are 10 settings for this feature. The timer can be set to run (Duration) from 1-99 seconds for each of the 10 settings. The timer also has a “Test” button will run the system for 10 seconds. The timer is mounted on the top of the Battery & Timer Mounting Bracket (Part F) with screws.
U. 12 v Battery—the battery is 7 Amp Hour Lead Acid housed in a high impact resistant case made of either non-conductive ABS plastic or styrene. It is approximately 6″×2.5″×4″ in size with two terminals on top. These batteries weigh approximately 6 lbs.
V. Battery & Timer Mounting Bracket—the Battery (Part E) and Timer (Part D) are fastened to the Container (Part C) by the Mounting Bracket (Part J). The bracket is made of aluminum and is fastened to the bottom of the Container with 2 mounting screws.
W. 12 v Pump/Motor—the 12 v Pump is a Positive Displacement 3 Chamber Diaphragm Pump. It contains a 2-way check valve which prevents reverse flow. The operational range is between 140-160 psi. It is also self priming. The motor is a Permanent Magnet, Thermally Protected, 12 VDC. This part weighs approximately 6 lbs.
X. Suction Tube—this is a ⅜″ diameter nylon tube that is used to draw the misting solution from the container reservoir into the Pump (Part G). It is approximately 18″ long.
Y. Return Tube—this is a ¼″ diameter nylon tube that is used to return the misting solution back into the reservoir and thus equalize the pressure. This feature keeps the pump running continuously during the spraying cycle. Because the pump runs continuously, the pressure of approximately 150 psi is maintained.
Z. Pump/Motor Mounting Bracket—the bracket is part of the Pump (Part G) and is used with the Mounting Screws (Part K) to fasten the Pump to the Container (Part C)
AA. Mounting Screws—used to fasten (Part J) to the Container (Part C).
BB. Nylon High-pressure Misting Tube—this is the ¼″ nylon tube that comes from the discharge side of the Pump (Part C). This tube is then attached to various items, such as awnings, lids, covers, trees, ceilings, etc., that cover the area to be sprayed with the misting solution. The final height of this tube should be 8′-10′ above the ground. Nozzles, described below, are then spliced into the tubing at the desired locations for the elimination and repelling of various insects.
CC. HDPE Lid—this is the part that covers the recessed compartment discussed in Part C above. It is made of the same material as the Container (Part C). Besides covering the recessed compartment, it functions as a cover over the Suction Tube (Part H) and Return Tube (Part I) and also helps to hold down the Filler Hole Plug (Part A). The Lid (Part M) is held in place by 4 thumbscrews (Part N)
DD. Lid Thumbscrews—the thumbscrews are made from Nickel-plated brass, ½″ long and are used to hold the Lid (Part M) in place. These thumbscrews are secured into inserts that are molded into the Container (Part C). There are a total of 4 thumbscrews for each Lid (Part M).
EE. Regular Nickel-plated Misting Nozzles—the nozzles are made of Nickel-plated brass. The regular nozzle has the following parts: (1) a drip-free nozzle tip made of stainless steel. An O-ring and a stainless steel check valve spring assure accurate shut-off at the orifice. A sintered bronze filter is also a part of the tip and is used to avoid clogging of the nozzle tip, (2) an adapter that the tip screws into, and (3) the union Tee. The tee is plugged into the top of the adaptor and then is spliced into the ¼″ tube at the appropriate spraying locations. Each tee has PrestoLoc (push then pull) fittings for ease of installation.
FF. Dead-end Nickel-plated Misting Nozzles—the nozzles are made of Nickel-plated brass. The dead -end nozzle has the following parts: (1) a drip-free nozzle tip made of stainless steel. An O-ring and a stainless steel check valve spring assure accurate shut-off at the orifice. A sintered bronze filter is also a part of the tip and is used to avoid clogging of the nozzle tip, (2) an adapter that the tip screws into, and (3) the union Elbow (90 degrees). The Elbow is plugged into the top of the adaptor and then is plugged into the ¼″ tube at the “last” spraying location. Each Elbow has a PrestoLoc (push then pull) fitting for ease of installation.

What is claimed is:

1. A Portable Insect Misting System comprising:
a 12 v digital timer;
a 2.75 gallon container;
a source of treating fluid;
an electrical power source;
a pump for pressurizing the treating fluid as needed to discharge the treating fluid at a predetermined discharge pressure and flow rate;
at least one spray nozzle configured to receive the pressurized treating fluid and to discharge the treating fluid in the form of a mist;
at least one flow conduit providing fluid communication between the source and the at least one spray nozzle;
an electronic control unit that initiates a flow of pressurized treating fluid to at least one sprayer head in response to a timer or trigger sensor.

2. The portable fluid mist sprayer system of claim 1 wherein the treating fluid is selected from liquids, gases, suspensions, and mixtures thereof.

3. The portable fluid mist sprayer system of claim 2 wherein the treating fluid is selected from the group consisting of insecticide, pesticide, fungicide, biocide, insect repellent, water, air, or mixtures thereof.

4. The portable fluid mist sprayer system of claim 2 wherein the treating fluid comprises an insect attractant.

5. The portable fluid mist sprayer system of claim 4 wherein the attractant is carbon dioxide gas.

6. The portable fluid mist sprayer system of claim 1 wherein the electronic control module further comprises a light level discrimination module, a pump controller module, and an RF receiver.

7. The portable fluid mist sprayer system of claim 1 wherein the electrical power source is at least one battery.

8. The portable fluid mist sprayer system of claim 1 wherein the size of the container has been designed to allow mixing the insecticide and water without measuring.

9. The portable fluid mist sprayer system of claim 1 wherein the system will spray up to ten (10) nozzles simultaneously.

10. The portable fluid mist sprayer system of claim 1 wherein a timer can be set to spray while people are away, or asleep.
